(19) United States
(12) Patent Application Publication
(10) Pub. No.: US 2006/0188417 A1
(43) Pub. Date: Aug. 24, 2006

(54) Radiant tubes arrangement in low NOx furnace

(76) Inventors: James R. Roth, Ponca City, OK (US); Vincent K. Leung, Ponca City, OK (US); Brian J. Doerksen, Ponca City, OK (US); Robin J. McGlynn, Ponca City, OK (US)

Correspondence Address: ConocoPhillips Company - I.P. Legal, P.O. BOX 2443, BARTLESVILLE, OK, 74005, US

(21) Appl. No.: 11/063,813

(22) Filed: Feb. 23, 2005

(51) Int. Cl. B01J 10/00

(52) U.S. Cl. 422/197; 422/198

(57) ABSTRACT

System and method are disclosed for increasing the effectiveness of the lower tubes in a delayed coker furnace. The system and method involve arranging the tubes so that the lower tubes are as close to the heat source as the upper tubes. Such an arrangement allows all the tubes to have substantially the same amount of radiant flux. In some implementations, it is also possible to conform the refractory floor to the arrangement of the tubes.

### FIELD OF THE INVENTION

The present invention relates generally to delayed cokers and particularly to a method and system for improving the efficiency of the radiant tubes in low NOx (nitric oxide (NO) and nitrogen dioxide (NO₂)) furnaces.

### BACKGROUND OF THE INVENTION

In the hydrocarbon processing industry, it is common to recover valuable products from the heavy residual oil that remains after refining operations are completed. This recovery process produces a useful byproduct called coke and is referred to as coking. Coking involves heating the residual oil feedstock above a certain cracking temperature and then cooling it. As the heated feedstock cools, it solidifies into a carbon based compound known as coke. The specifics of the coking process are well-known to those having ordinary skill in the art and will therefore be discussed only generally here.

The feedstock is brought to above the cracking temperature in a coker furnace, an example of which is shown in FIGS. 1A-1B. As can be seen, the coker furnace 100 typically includes a housing 102 surrounding a refractory floor 104 and having an inlet 106 and an outlet 108. A plurality of tubes 110 are provided for conducting the feedstock from the furnace inlet 106 to the furnace outlet 108. The tubes 110 are connected end-to-end in series to form one continuous conduit that snakes back and forth from the inlet 106 to the outlet 108. Feedstock is then pumped from a distiller (not shown) through the tubes 110 where it is heated in the furnace 100 and subsequently emptied into awaiting coke drums (also not shown).

FIG. 1B shows a cross-section of the furnace 100 in FIG. 1A along line B-B. As can be seen, the heat from the furnace 100 is provided by a burner 112, usually a low NOx burner, that produces an extremely high temperature flame 114. The tubes 110 are typically arranged in two bundles 116a and 116b that form substantially vertical columns on either side of the flame 114. Heat transfer takes place primarily via radiation (as opposed to convection or conduction) and therefore the tubes 110 are often referred to as radiant tubes.

The tubes 110 need to remain clear of any obstructions in order to maintain an essentially steady and continuous flow of feedstock. For this reason, much time and effort have been expended in the hydrocarbon processing industry to ensure that no formation of coke takes place in the tubes 110. In particular, the number and placement of the tubes 110, the flow rate of the feedstock through the furnace 100, and other factors have been balanced so that the feedstock will be heated to above the cracking temperature while in the tubes 110, but coking is delayed until the feedstock is emptied into the coke drums.

Unfortunately, NOx is considered toxic and thought by many people to play a major role in the formation of acid rain, smog, and ozone. Therefore, there is a push in the industry and among environmental groups to move towards low NOx burners. Low NOx burners, however, release heat at a higher point in the flame 114 compared to other types of NOx burners. As a result, the bottom and lower tubes, indicated generally at 118a and 118b, tend to have extremely low radiant flux. The term “radiant flux,” as used, herein, means the rate at which heat is transferred to the tubes 110.

Low radiant flux can cause a number of problems, including lowering of the feedstock temperature at the furnace outlet 108. Consequently, in order to maintain the desired temperature at the outlet 108, higher radiant flux is needed at the middle and upper tubes. Higher radiant flux at the middle and upper tubes, however, may cause premature coking in these tubes. Premature coking may also occur in the lower radiant tubes 118a and 118b because the lower radiant flux at these tubes contribute little duty to the furnace 100, which translates effectively to increased residence time for the feedstock. This additional residence time can lead to premature coking in the lower tubes 118a and 118b.

Coking in any one of the tubes 110 may restrict the flow of feedstock through the furnace 100. The restricted flow may increase the residence time of the feedstock, which may lead to deposition of additional coke. The coke deposits may also have the effect of insulating the tube section so that more heat must be applied to achieve the desired rate of heating. All these factors tend to encourage the formation of still more coke within the tubes 110, further exacerbating the problem.

If the temperature of a tube 110 increases too much, a tube rupture can occur. The likelihood of tube rupture is also aggravated by the fact that the feed must be pumped at ever-higher pressures as the flow is restricted by coke deposition in the tubes 110. The combination of exposing the tubes to higher temperatures and higher pressures greatly increases the probability of tube rupture and total shut down of the delayed coking process.

Accordingly, what is needed is a way to increase the effectiveness of the lower tubes in furnaces that use low NOx burners. More particularly, what is needed is a way to increase the radiant flux of the lower tubes in low NOx furnaces.

### SUMMARY OF THE INVENTION

The present invention is directed to a method and system for increasing the effectiveness of the lower tubes in a delayed coker furnace. The invention involves arranging the tubes so that the lower tubes are as close to the heat source as the upper tubes. Such an arrangement allows all the tubes to have substantially the same amount of radiant flux. In some implementations, it is also possible to conform the refractory floor to the arrangement of the tubes.

In general, in one aspect, the invention is directed to a delayed coker furnace. The delayed coker furnace comprises a housing having an inlet and an outlet and a heat source disposed in the housing, the heat source providing radiant heat for the furnace. The delayed coker furnace further comprises a plurality of substantially parallel radiant tubes connected in series for carrying feedstock from the inlet of the housing past the heat source to the outlet of the housing, the plurality of radiant tubes including a first set of radiant tubes and a second set of radiant tubes. The first set of radiant tubes is arranged substantially vertically in the housing, while the second set of radiant tubes is inset toward the heat source relative to the first set of radiant tubes.

In general, in another aspect, the invention is directed to a method of improving an efficiency of a delayed coker furnace, the furnace having a plurality of substantially parallel radiant tubes disposed therein and connected in series for carrying feedstock through the furnace. The method comprises the steps of arranging a first set of the radiant tubes substantially vertically in the furnace, and arranging a second set of radiant tubes in the furnace beneath the first set of radiant tubes, the second set of radiant tubes being inset toward a heat source relative to the first set of radiant tubes.

In general, in still another aspect, the invention is directed to an arrangement of radiant tubes in a delayed coker furnace, the radiant tubes disposed substantially parallel to each other and connected in series. The arrangement comprises a first set of the radiant tubes, the radiant tubes arranged adjacent to one another in a column. The arrangement further comprises a second set of radiant tubes, the radiant tubes arranged adjacent to one another beneath the first set of radiant tubes. The second set of radiant tubes is inset toward a heat source relative to the first set of radiant tubes.

### BRIEF DESCRIPTION OF THE DRAWINGS

The foregoing and other aspects of the invention will become apparent from the following detailed description and upon reference to the drawings, wherein:

FIGS. 1A-1B illustrate a prior art delayed coker furnace;

FIG. 2 illustrates a delayed coker furnace according to embodiments of the invention where the lower tubes have been moved closer to the heat source; and

FIG. 3 illustrates a delayed coker furnace according to embodiments of the invention where the refractory floor has been conformed to the lower tubes.

### DESCRIPTION OF ILLUSTRATIVE EMBODIMENTS OF THE INVENTION

Following is a detailed description of exemplary embodiments of the invention with reference to the drawings where the same reference labels are used for the same or similar elements. It should be noted that the drawings are provided for illustrative purposes only and are not intended to be a blueprint or drawn to any particular scale.

As mentioned above, embodiments of the invention provide a method and system for increasing the radiant flux of the lower tubes in a delayed coker furnace. While these embodiments are described with respect to low NOx furnaces, the invention is not to be limited thereto, but may be equally applicable to other types of furnaces.

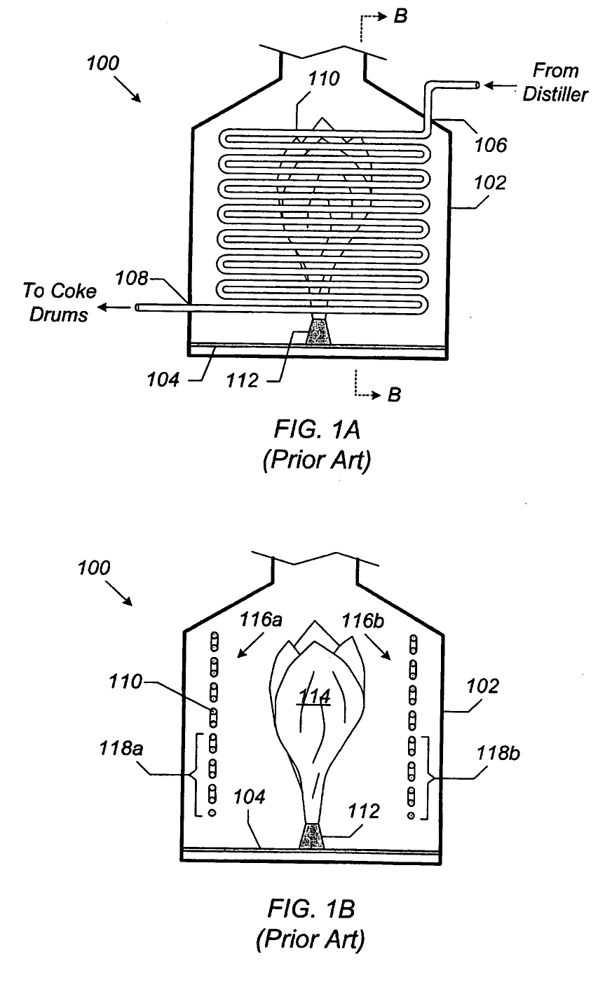

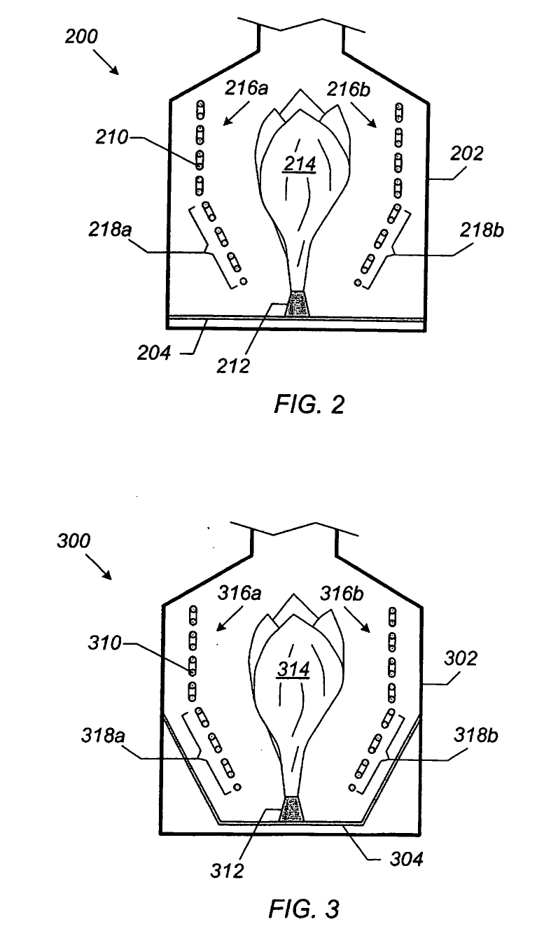

Referring now to FIG. 2, a cross-sectional view of a coker furnace 200 according to embodiments of invention is shown. The coker furnace 200 is similar to the coker furnace 100 of FIG. 1 in that it includes a housing 202 surrounding a refractory floor 204 and having an inlet 206 and an outlet 208. A plurality of tubes 210 are arranged on either side of a burner 212, and the flame 214 produced therefrom, for heating the feedstock flowing through the tubes 210. The burner 212 in this implementation is a low NOx burner and, therefore, the heat is released at a higher point on the flame 214, resulting in lower radiant flux near the bottom of the coker furnace 200.

In accordance with embodiments of the invention, the tubes 210 are arranged in two non-planar bundles 216a and 216b instead of two vertical columns (see tube bundles 116a and 116b in FIGS. 1A-1B). More specifically, the upper tubes in the bundles 216a and 216b remain in the same place as before (since they are already near the heat release area), but the lower tubes 218a and 218b are moved in towards the flame 214. Such an arrangement increases the radiant flux of the lower tubes 218a and 218b, thus avoiding the problems mentioned earlier with respect to low radiant flux in the lower tubes. The physical mounting of the lower tubes 218a and 218b is well within the skills of those having ordinary skill in the art and will therefore not be discussed here.

In some embodiments, the lower tubes 218a and 218b are arranged so that all the lower tubes 218a and 218b have about the same amount of radiant flux. Thus, for example, each one of the lower tubes 218a and 218b may be inset to by a predetermined amount that is slightly more than the one immediately above, as shown in FIG. 2. Preferably, the distance that each one of the lower tubes 218a and 218b is inset allows it to have substantially the same amount of radiant flux as the one above it.

In some embodiments, although not shown here, rather than have each one of the lower tubes 218a and 218b be inset slightly more than the one immediately above, the lower tubes 218a and 218b may all be inset by the same amount. Alternatively, each one of the lower tubes 218a and 218b may be inset slightly more than the one immediately above, but the amount of inset may increase or decrease non-linearly for each tube section. Other arrangements of the tubes 210 in addition to those mentioned above are also within the scope of the invention.

In some embodiments, instead of a flat refractory floor (see floor 104 in FIGS. 1A-1B), the floor may instead be conformed to the arrangement of the lower tubes. This is illustrated in FIG. 3, where a cross-sectional view of another coker furnace 300 according to embodiments of the invention is shown. The coker furnace 300 is similar to the coker furnace 200 of FIG. 2, except that the refractory floor 304 has been conformed to match the arrangement of the bundles 316a and 316b of tubes 310. More specifically, the side portions of the floor 304 have been turned up at a predetermined angle so that they are substantially parallel to the lower tubes 318a and 318b.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A delayed coker furnace, comprising:
a housing having an inlet and an outlet;
a heat source disposed in said housing, said heat source providing radiant heat for said furnace; and
a plurality of substantially parallel radiant tubes connected in series for carrying feedstock from said inlet of said housing past said heat source to said outlet of said housing, said plurality of radiant tubes including a first set of radiant tubes and a second set of radiant tubes;
wherein said first set of radiant tubes is arranged substantially vertically in said housing and said second set of radiant tubes is inset toward said heat source relative to said first set of radiant tubes.

2. The delayed coker furnace according to claim 1, wherein each radiant tube of said second set of radiant tubes is inset more than a radiant tube above it by a predetermined amount.

3. The delayed coker furnace according to claim 1, wherein two or more radiant tubes of said second set of radiant tubes is inset by substantially the same amount.

4. The delayed coker furnace according to claim 1, wherein two or more radiant tubes of said second set of radiant tubes has substantially the same amount of radiant flux.

5. The delayed coker furnace according to claim 1, wherein said second set of radiant tubes has substantially the same amount of radiant flux as said first set of radiant tubes.

6. The delayed coker furnace according to claim 1, wherein said burner is a low nitric oxide or low nitrogen dioxide burner.

7. The delayed coker furnace according to claim 1, said plurality of radiant tubes further includes a third set of radiant tubes and a fourth set of radiant tubes, said third set of radiant tubes arranged substantially vertically in said housing opposite said first set of radiant tubes and said fourth set of radiant tubes is inset toward said heat source relative to said third set of radiant tubes.

8. The delayed coker furnace according to claim 1, further comprising a refractory floor supporting said burner, said refractory floor conformed to said second set of radiant tubes.

9. A method of improving an efficiency of a delayed coker furnace, said furnace having a plurality of substantially parallel radiant tubes disposed therein and connected in series for carrying feedstock through said furnace, comprising:
arranging a first set of said radiant tubes substantially vertically in said furnace; and
arranging a second set of radiant tubes in said furnace beneath said first set of radiant tubes, said second set of radiant tubes being inset toward a heat source relative to said first set of radiant tubes.

10. The method according to claim 9, further comprising insetting each radiant tube of said second set of radiant tubes more than a radiant tube above it by a predetermined amount.

11. The method according to claim 9, further comprising insetting two or more radiant tubes of said second set of radiant tubes by substantially the same amount.

12. The method according to claim 9, wherein two or more radiant tubes of said second set of radiant tubes receive substantially the same amount of radiant flux.

13. The method according to claim 9, further comprising:
arranging a third set of said radiant tubes substantially vertically in said furnace and opposite said first set of radiant tubes; and
arranging a fourth set of radiant tubes in said furnace beneath said third set of radiant tubes, said fourth set of radiant tubes being inset toward said heat source relative to said third set of radiant tubes.

14. An arrangement of radiant tubes in a delayed coker furnace, said radiant tubes disposed substantially parallel to each other and connected in series, comprising:
a first set of said radiant tubes, said radiant tubes arranged adjacent to one another in a column; and
a second set of radiant tubes, said radiant tubes arranged adjacent to one another beneath said first set of radiant tubes;
wherein said second set of radiant tubes is inset toward a heat source relative to said first set of radiant tubes.

15. The arrangement according to claim 14, wherein each radiant tube of said second set of radiant tubes is inset more than a radiant tube above it by a predetermined amount.

16. The arrangement according to claim 14, wherein two or more radiant tubes of said second set of radiant tubes is inset by substantially the same amount.

17. The arrangement according to claim 14, wherein two or more radiant tubes of said second set of radiant tubes has substantially the same amount of radiant flux.

18. The arrangement according to claim 14, wherein said second set of radiant tubes has substantially the same amount of radiant flux as said first set of radiant tubes.

19. The arrangement according to claim 14, further comprising:
a third set of radiant tubes arranged adjacent one another; and
a fourth set of radiant tubes arranged adjacent one another and beneath said third set of radiant tubes, said fourth set of radiant tubes being inset toward said heat source relative to said third set of radiant tubes.
